(19) United States
(12) Patent Application Publication
(10) Pub. No.: US 2013/0260360 A1
(43) Pub. Date: Oct. 3, 2013

(54) METHOD AND SYSTEM OF PROVIDING INTERACTIVE INFORMATION

(71) Applicants: Travis Baurmann, San Diego, CA (US); Thomas Dawson, Escondido, CA (US); Marvin DeMerchant, San Deigo, CA (US); Steven Friedlander, San Diego, CA (US); Seth Hill, La Mesa, CA (US); Hyehoon Yi, Escondido, CA (US); David Young, San Diego, CA (US); James R. Milne, Ramona, CA (US)

(72) Inventors: Travis Baurmann, San Diego, CA (US); Thomas Dawson, Escondido, CA (US); Marvin DeMerchant, San Deigo, CA (US); Steven Friedlander, San Diego, CA (US); Seth Hill, La Mesa, CA (US); Hyehoon Yi, Escondido, CA (US); David Young, San Diego, CA (US); James R. Milne, Ramona, CA (US)

(73) Assignee: SONY CORPORATION, Tokyo (JP)

(21) Appl. No.: 13/431,638

(22) Filed: Mar. 27, 2012

(51) Int. Cl. G09B 25/00

(52) U.S. Cl. 434/365

(57) ABSTRACT

Some embodiments provide methods for use in providing information. These methods comprise: capturing, with one or more cameras of a display device, video along a first direction; detecting an object of interest that is captured in the video; obtaining additional information corresponding to the object of interest; determining an orientation of a user relative to a display of the display device, where the display is oriented opposite to the first direction; determining portions of each of the video images to be displayed based on the determined orientation of the user such that the portions of the video images are configured to appear to the user as though the display device were not positioned between the user and the object of interest; and displaying the portions of video images as they are captured and simultaneously displaying the additional information in cooperation with the object of interest.

### BACKGROUND

1. Field of the Invention

The present invention relates generally to providing information, and more specifically to providing information relative to an object of interest.

2. Discussion of the Related Art

The use of consumer electronic devices continues to increase. More and more users carry portable consumer electronic devices that provide wide ranges of functionality. Users become more reliant on these devices. Further, users continue to expect additional uses from these electronic devices.

### SUMMARY OF THE INVENTION

Several embodiments of the invention advantageously address the needs above as well as other needs by providing methods of providing additional information. In some embodiments, methods of providing information, comprise: capturing, with one or more cameras of a display device, video along a first direction, the video comprising a series of video images; detecting a first object of interest that is captured in the video; obtaining additional information corresponding to the first object of interest; determining an orientation of a user relative to a display of the display device, where the display is oriented opposite to the first direction; determining portions of each of the video images to be displayed on the display based on the determined orientation of the user relative to the display such that the portions of the video images when displayed are configured to appear to the user as though the display device were not positioned between the user and the first object of interest; and displaying, through the display device, the portions of video images as they are captured and simultaneously displaying the additional information in cooperation with the first object of interest.

Other embodiments provide systems of providing information corresponding to an object of interest. Some of these embodiments comprise: means for capturing video along a first direction, the video comprising a series of video images; means for detecting a first object of interest that is captured in the video; means for obtaining additional information corresponding to the first object of interest; means for determining an orientation of a user relative to a display of the display device, where the display is oriented opposite to the first direction; means for determining portions of each of the video images to be displayed on the display based on the determined orientation of the user relative to the display such that the portions of the video images when displayed are configured to appear to the user as though the display device were not positioned between the user and the first object of interest; and means for displaying the portions of video images as they are captured and simultaneously displaying the additional information in cooperation with the first object of interest.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts a simplified flow diagram of a process of providing and/or displaying additional information corresponding to an object of interest, in accordance with some embodiments.

FIG. 2A shows a simplified perspective view of a display device positioned proximate an object of interest, in accordance with some embodiments.

FIG. 2B shows a simplified perspective view of the display device positioned from a user's perspective relative an object of interest, in accordance with some embodiments.

FIG. 3A depicts a simplified plane view of a display device, according to some embodiments, with the display device oriented to show a display of the display device.

FIG. 3B depicts a simplified plane view of the display device of FIG. 3A while being oriented to show a casing or back side of the display device.

FIGS. 4A-4B show a simplified overhead and side views, respectively, of a display device and further illustrates the variations in the selection of portions or subsets of images captured by the forward cameras of the display device, in accordance with some embodiments.

FIGS. 5A-5D show simplified views of display devices illustrating the variations in the selection of portions of the images based on a distance orientation of a user, in accordance with some embodiments.

FIG. 6 shows a simplified perspective view of a back side of a display device, in accordance with some embodiments.

FIG. 7 shows a simplified representation, corresponding with one of the forward cameras of the display device, of a portion or subset of a field of view that is selected based on the determined orientation of the user, in accordance with some embodiments.

FIG. 8 depicts simplified graphical representation of parameter used in determining a user's orientation, in accordance with some embodiments.

FIG. 9 depicts simplified graphical representation of parameters used in determining a user's orientation, in accordance with some embodiments.

FIG. 10 depicts a simplified flow diagram of a process in providing additional information relevant to an object of interest, according to some embodiments.

FIG. 11 depicts a simplified flow diagram of a process of recognizing an object of interest and providing interaction with the object of interest in accordance with some embodiments.

FIG. 12 depicts a simplified flow diagram of a process of displaying on a display device additional information that corresponds to an object of interest, in accordance with some embodiments.

FIG. 13 depicts a simplified flow diagram of a process of detecting an orientation of a user relative to the display device in accordance with some embodiments.

FIG. 14 shows a simplified flow diagram of a process of allowing a user to interact with the display device and/or the additional information being displayed in association with the identified object of interest, in accordance with some embodiments.

FIG. 15 illustrates a system for use in implementing methods, techniques, devices, apparatuses, systems, servers, sources and the like in providing a user with additional information relevant to a recognized object of interest, in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations” or similar language means that a particular feature, structure, or characteristic described in connection with the embodiment is included in at least one embodiment of the present invention. Thus, appearances of the phrases “in one embodiment,” “in an embodiment,” “in some embodiments,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present embodiments provide additional information relative to an object or device of interest. The object of interest can be displayed on a display device as the user is looking at a displayed image of the object of interest and surrounding environment captured through one or more cameras incorporated with the display device. Accordingly, in at least some instances, the displayed view presented on the display device corresponds to a view that the user would be seeing should the display device be moved. With this view, the user appears to be looking “through” the display device while the display device is configured to further display additional information corresponding to the device or object of interest.

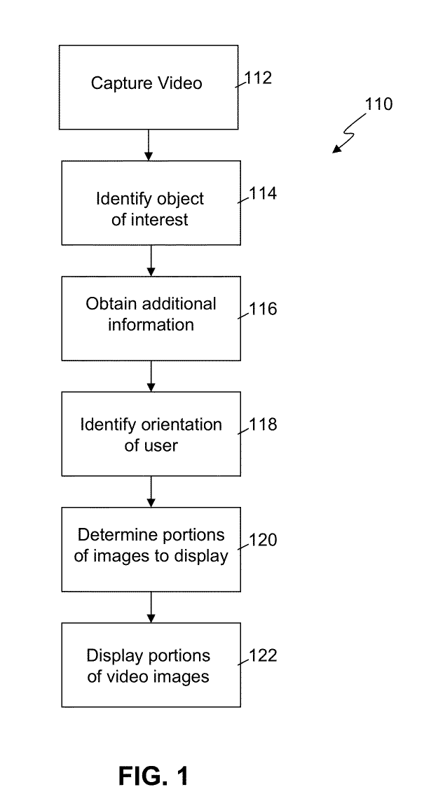

FIG. 1 depicts a simplified flow diagram of a process 110 of providing and/or displaying additional information corresponding to an object of interest, in accordance with some embodiments. In step 112, a video or sequence of images is captured by one or more cameras directed along a first direction, typically away from a user. In step 114, one or more objects of interest within the video are detected, selected and/or identified.

In step 116, additional information is obtained corresponding to the object or objects of interest. In step 118, an orientation of a user relative to a display of a display device is determined. Typically, the user is looking at the display, and thus, the display is typically oriented opposite or 180 degrees to the first direction. In step 120, portions or subsets of each of the images of the video to be displayed on the display are determined based on the orientation of the user relative to the display. In some embodiments, the portions of the video images are determined such that when they are displayed they are configured to appear to the user as though the display device were not positioned between the user and the object of interest. In step 122, the portions of video images are displayed as they are captured in real time while the additional information is displayed in cooperation with the object of interest. Typically, the additional information is simultaneously displayed while displaying the portions of the captured images. When the portion of the video image includes multiple objects of interest, in some instances additional information can be displayed in cooperation with each of the objects of interest, when space is available. When space is not available, one or more other actions may be take, such as prioritizing the one or more objects of interest and displaying additional information according to spacing and prioritization, forcing a reorientation of the display device (e.g., from landscape to portrait), and/or other such actions.

The images are typically captured by one or more cameras incorporated into the playback device. Further, some embodiments utilize two cameras to allow the playback device to display the video and/or images three-dimensionally. For example, the display device may include a three-dimensional (3D) display that can utilize the two different videos captured by the two cameras in providing a 3D playback of the video. In some instances, the positioning of the cameras on the display device is such that they are separated by a distance. The distance can be substantially any distance, and in some embodiments, is approximately equal to the average distance between the eyes of an average human adult. The one or more cameras are typically positioned within a housing of the playback device. The fields of view of the one or more cameras are along a first direction that is generally 180 degrees away from the display of the display device, such that the fields of view of the cameras are generally parallel to a user's field of view as the user looks at the display.

The fields of view of the cameras can be relatively large to accommodate various user orientations relative to the display device. Additionally, the fields of view can be configured based on the size of the display device, how much of a user's field of view the display device is likely to occupy, and other such relevant factors. In some embodiments, one or more of the cameras can be high definition cameras to provide higher resolution video and/or images.

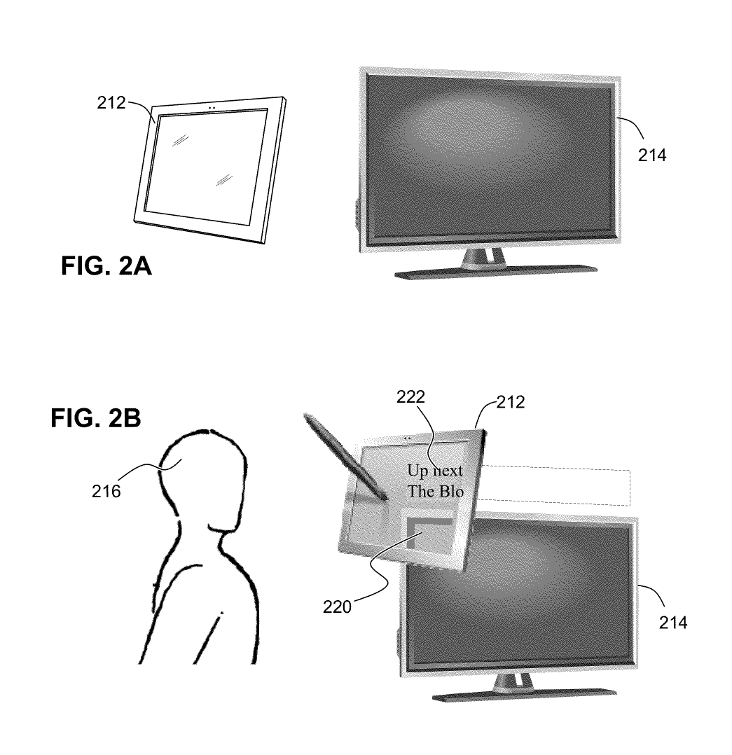

FIG. 2A shows a simplified perspective view of a display device 212 positioned proximate an object or device of interest 214, which in this embodiments is a television. FIG. 2B shows a simplified perspective view of the display device 212 positioned from a user's perspective relative the object of interest 214. Accordingly, the display device 212 captures video. Based on the perspective of the user 216, the display device identifies portions of frames of the video to display (or playback) and displays those portions of the images providing the user 216 with the appearance as though the user were looking through the display device 212 and/or as though display device were not positioned between the user and the object of interest. Further, in displaying the portions of the video images, some embodiments display the portions of the video images three-dimensionally such that the displayed portions of the video images appear to the user as having depth consistent with what the user would otherwise see should the display device 212 be removed from the user's field of view. In the example in FIG. 2B, the display device 212 displays a portion 220 of the object of interest along with a portion of the surrounding environment.

As described above, the display device 212 can further display additional information 222 relative to the object of interest 214. For example, when the user 216 is watching TV 214, the additional information 222 can include information about the program being watched, subsequent or alternative television programs that might be available, links to information related to the television program, information about the TV 214 (e.g., user guide information and/or access to user guide information), and/or other information relevant to the object of interest 214. Similarly, the additional information 222 may include controls to allow a user 216 to control the object of interest, such as turn up the volume, select a different channel or program, record a program, view and navigate through an electronic programming guide, and/or other such information. Still further, the additional information 222 can be displayed so that it does not interfere with the object of interest 214. For example, the additional information 222 is displayed by the display device 212 within the images and above the displayed portion of the object of interest 214 (e.g., displayed above the displayed TV without obscuring the TV and/or video on the display of the TV). In some implementations, the displayed additional information 222 can be displayed by the display device 212 relative to object of interest 214 to remain in a same position or orientation regardless of the viewing angle of the display device 212. Other users or viewers of the object of interest 214 looking at the object of interest from another perspective typically will not be able to view the display device 212, and thus, will not see the additional information.

The display device 212 can be substantially any display device capable of capturing a sequence of images and/or video in a given direction and playing at least portions of each image of the sequence or video relative to a user's perspective. For example, the display device 212 can be, but is not limited to, a smart phone, a tablet computing device, a media playback device, a Tablet S, an iPad, an iPhone, an iTouch, a camera, a video camera, other such portable and/or handled devices, or other such relevant devices. Accordingly, the display device, in some instances, can operate as a standard device without providing additional information as described herein, while in other instances the display device can operate to provide the additional information. In yet other embodiments, the display device may be exclusive configured to solely operate as described herein to provide the additional information. In some embodiments, the display device comprises a Stereo Augmented Reality (S.A.R.) display devices 212 (e.g., tablet). The SAR device can provide head tracking cameras (e.g., display side cameras 320-321) that can be used to align the stereo view with the head and/or eye position of the user.

The object of interest 214 can be substantially anything that can be identified by the display device 212 (or identification information provided to the display device) or another device or service, and for which the display device can display relevant information. For example, devices of interest can include, but are not limited to, multimedia playback devices (e.g., TV, set-top-box, Blu-ray player, DVD player, amplifier, radio, tablet computing device, Tablet S, iPad, iTouch, and other such devices), appliances, businesses and/or business signs, points of interest, or other such objects. In some instances, the display device may take into consideration other information in identifying an object of interest, such as geographic and/or global position system (GPS) information, orientation and/or compass information, accelerometer information, map information, image capture information, communication information (e.g., from the object of interest (e.g., WiFi, LAN, etc.)), and/or other such information. For example, the display device may include an internal accelerometer (e.g., 3 degrees of freedom (DOF), 6 DOF or other accelerometer).

In some instances, a remote device or service may identify the object of interest. For example, one or more images or frames, or a portion of video may be forwarded to a third party service, such as communicated over a network, the Internet or other communication method or methods. The third party can identify one or more of the object of interest (or potential objects of interest) and forward back additional information corresponding to each of the one or more devices of interest.

For example, the step 114 of FIG. 1 can include, in some embodiments, the one or more images can be evaluated to select one or more potential objects of interest. The playback device can then attempt to identify the one or more potential objects of interest. If one or more of the potential objects of interest cannot be identified, the playback device may request support from one or more remote devices and/or services, such as over the Internet. When the one or more remote services can identify one or more of the potential objects of interest they can return the one or more identifications to the playback device. Other information may be included such as the additional information that may be displayed relative to the object of interest. The identification information may also include some way for the playback device to identify within the image(s) and/or video which device is being identified, such as coordinate information of the image(s), size, shape, color and/or other such information. Accordingly, the playback device in identifying an object of interest can determine an identification of one or more object of interest itself and/or with the help of a remote device or service.

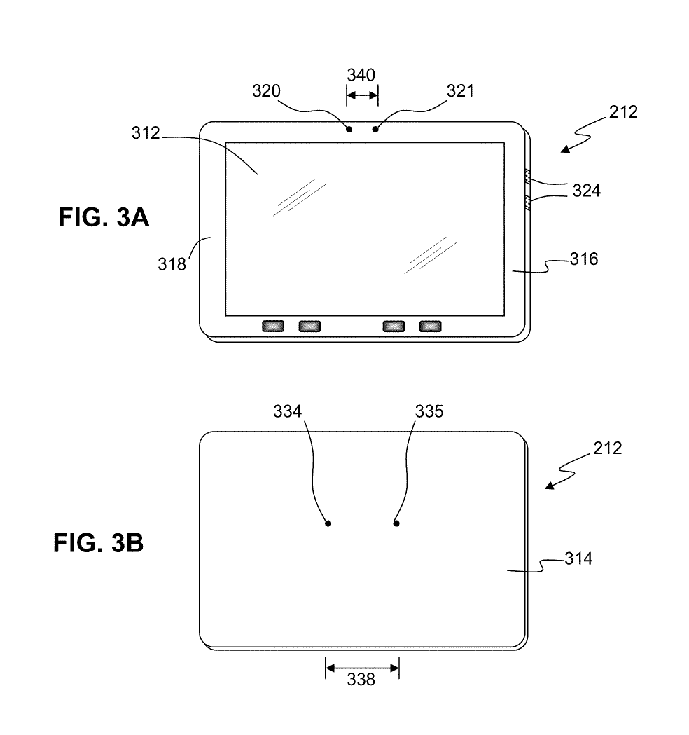

FIG. 3A depicts a simplified plane view of a display device 212, according to some embodiments, with the display device oriented to show the display 312 of the display device. FIG. 3B depicts a simplified plane view of the display device 212 of FIG. 3A while being oriented to show a casing or back side 314 of the display device 212. Referring to FIGS. 3A-B, on a display or front side 316, the display device 212 includes the display 312 positioned within a housing 318. The housing 318 extends around to the back side 330. In some embodiments, the display device 212 can include one or more input/output (I/O) portions or other communication interfaces 324. The display device 212, in some instances, further includes one or more display side cameras 320-321.

One or more forward directed cameras 334-335 (referred to below as forward cameras) are positioned relative to the back side 314. Typically, the forward cameras 334-335 are relatively high resolution cameras, and in some instances are high definition (HD) resolution cameras (e.g., typically 1 Megapixel or more). As described above, in some embodiments, two or more forward cameras 334-335 are included and are separated by a distance 338, where in at least some implementations the distance 338 is approximately equal to an average distance between the eyes of an average human adult. Accordingly, the playback of video based on the video captured by the two or more forward cameras 334-335 can allow the display device 212 to display the video with the appearance of three-dimensions (3D). In some implementations, the display 312 is configured to playback the video in 3D. For example, the display 312 can comprise a lenticular display that provides the 3D stereo viewing without the need for special glasses, or other displays that may or may not need the user of special glasses or goggles. For example, the display device 212 can include a lenticular or other “glasses free” approach to stereo video. In other implementations, LCD shutter glasses, polarized filter glasses or other such glasses, goggles or other such devices could be used. Many embodiments, however, display in 3D, which allows the display device 212 to use the stereo view to allow the user to, in a virtual sense, “look through” the display device 212. Accordingly, in many instances, the user's focus of interest is not the surface of the display 312 of the display device 212, but instead the object of interest 214, which may be virtually displayed as not being at the surface of the display device but visually at a distance from the user.

In some instances, the display 312 can be a touch screen allowing user interaction by touching the screen (e.g., zoom pinching, scrolling, selecting options, implement commands, and/or other such action). For example, the display device 212 may display a sign of a restaurant further down the street, with additional information displaying a menu, partial menu or option to access a menu for the restaurant. The user may be able to zoom in the image to get a better view, to more clearly identify an object of interest (e.g., zooming in on the sign of the restaurant), or the like. Further, one or more buttons, track balls, touch pads or other user interface components can be included on the display device 212. In some embodiments, the one or more display side cameras 320-321 have resolutions that are lower than those of the forward cameras 334-335. The display side cameras 320-321 can also be separated by a distance 340 allowing for more accurate determination of a location and/or orientation of the user 216.

The forward cameras 334-335 are oriented to have a field of view that is 180 degrees away from the display 312 and generally in parallel with a field of view of a user 216 when the user is aligned (e.g., centered vertically and horizontally relative to the display 312) with the display 312 and looking at the display. With this orientation the forward cameras 334-335 capture video and/or images of what the user 216 would be seeing if the display device 310 were not positioned within the user's field of view. In some embodiments, the forward cameras 334-335 are configured with a relatively wide field of view and employ wide view lenses. In some instances, the fields of view of the forward cameras 334-335 can be greater than the field of view of an average adult human.

The display side cameras 320-321 can be configured to capture images and/or video of a user 216. These images and/or video can be evaluated in tracking the orientation of the user's head and/or eye position. Based on the user's orientation, the display device 212 can determine which portions of the video or images captured by the forward cameras 334-335 are to be displayed to provide the user 216 with an accurate representation relative to the user's field of view.

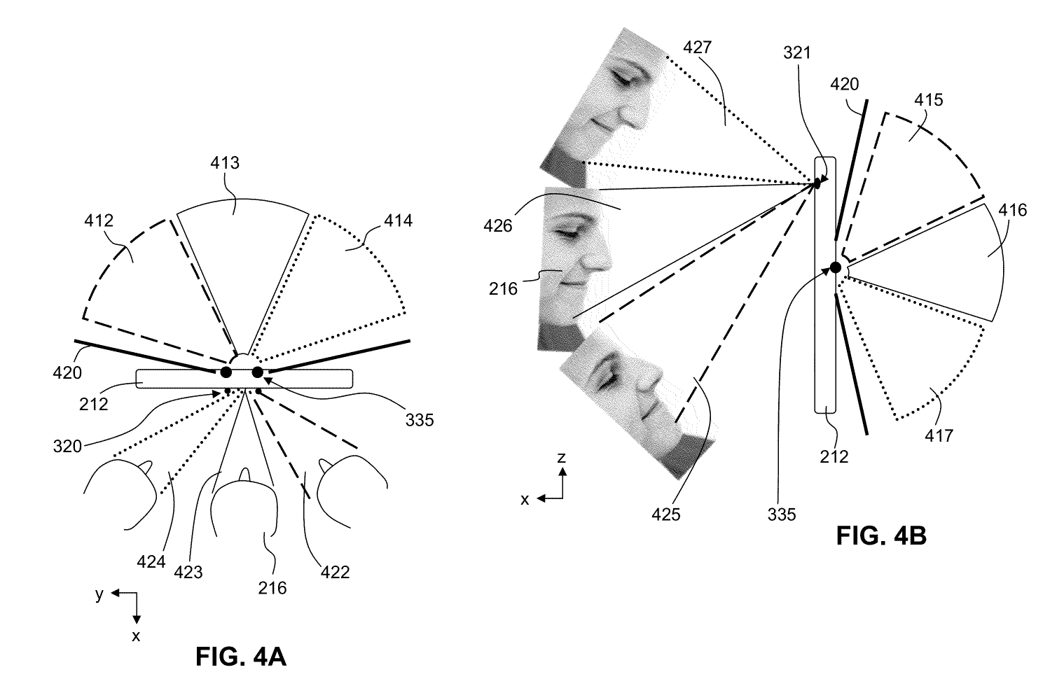

FIGS. 4A-4B show a simplified overhead and side views, respectively, of a display device 212 and further illustrates the variations in the selection of portions or subsets 412-417 of the images captured by the forward cameras 334-335 based on horizontal (y) orientation and/or vertical (x) orientation of a user 216 relative to the display device 212, in accordance with some embodiments. Illustrated in FIGS. 4A-4B, as the angle of the user 216 changes relative to the display 312 of the display device 212 the subset of the wide view angle images used for the stereo display is correspondingly varied. Again, the forward cameras 334-335 have a relatively wide field of view 420. As the user 216 moves relative to the display device 212, the portion of the images captured by the forward cameras 334-335 that are selected to be displayed on the display device varies (or moves) corresponding to the user's movements.

Referring to FIG. 4A, the display side cameras 320-321 are used to track a user's orientation relative to the display device 212. As the user moves laterally (y) relative to the display device the portion of the image captured to be displayed is correspondingly varied. For example, when a user 216 is oriented at a first angle 422 (e.g., to the right) relative to the display device 212, a first portion 412 of the image generally toward a left side of the field of view is defined to be displayed. As the view moves toward a second angle 223 (e.g., center orientation), a second portion 413 of the capture image is defined to be displayed.

Additionally, the portions 412-417 of the captured images to be displayed are also affected by the vertical angle or orientation the user is relative to the display device 212. For example, when a user is orientation at an angle below 425 the display device, the portion of the images displayed are defined by a fourth portion 415. As the user moves up toward a center orientation 226 the display device, fifth portion 416 of the capture image is defined to be displayed. Again, as the user moves up toward above 227 the display device 212, a sixth portion 417 of the capture image is defined to be displayed.

It is noted that in FIGS. 4A-4B the angles or amounts 430 of the portions of the image displayed as the orientation of the user changes are shown as substantially equal; however, the angles 430 of the portions typically vary and may vary widely depending on an orientation of the user. Similarly, as described below, the angle 430 of the portion of the image to be displayed also varies as the user moves closer to and/or further way from (depicted in FIGS. 4A-4B as the “x” direction) the display device 212. Further, the portions 412-417 of the captured images are shown as incremental for illustration purposes; however, the displayed portions are not incremental and instead extend continuous and overlapping across then entire field of view 420 of the forward cameras 334-335.

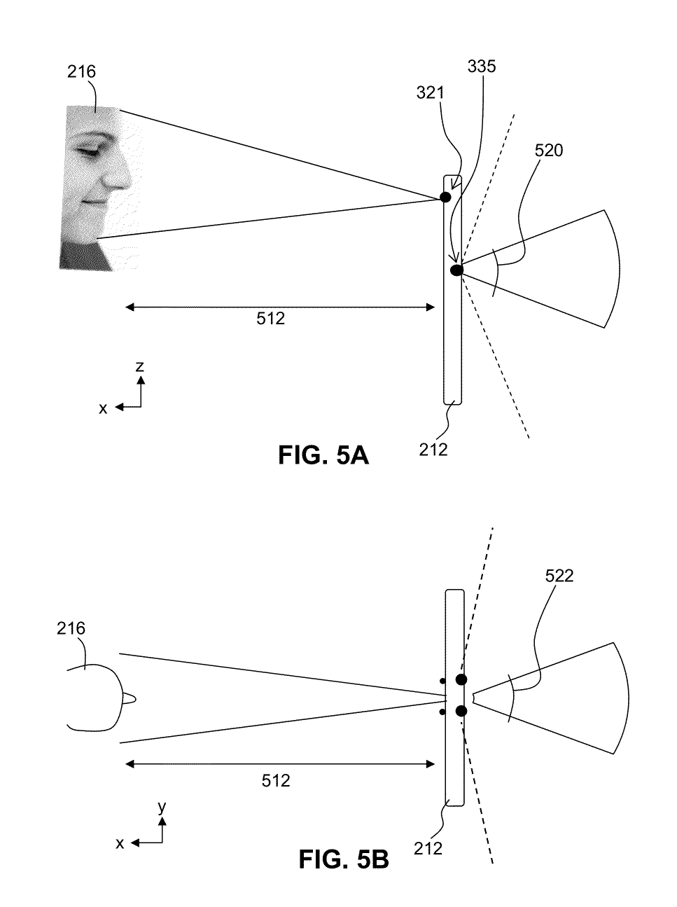

FIGS. 5A and 5C show simplified side views and FIGS. 5B and 5D show simplified overhead views of a display device 212 illustrating the variations in the selection of portions 412-417 of the images captured by the forward cameras 334-335 based on a distance or depth (x) orientation of a user 216 relative to the display device 212, in accordance with some embodiments. As the distance of the user's head from the display device varies, based on head and/or eye tracking, both the horizontal angle and vertical angle used to select the subset of the camera image to be displayed correspondingly change.

Referring to FIGS. 5A-5B, based on a determination of the user's 212 distance (first distance 512) from display device 212, the display device calculates a first horizontal angle 520 and first vertical angle 522 of the forward cameras' field of view to use in selecting the portion of the camera images to be displayed. As the distance between the user 216 and the display device 212 changes, one or both the vertical and horizontal angles of the fields of view used to select the portions of the camera images to use changes.

FIGS. 5C-5D show the user 216 at a second distance 514 (in this example, closer) from the display device 212. Accordingly, the display device calculates a second horizontal angle 524 and second vertical angle 526 of the forward cameras' field of view to use in selecting the portion of the camera images to be displayed. Again, in this example, the user is closer to the display device 212, and accordingly, the vertical and horizontal angles increase such that the second horizontal angle 524 and second vertical angle 526 are larger that the first horizontal angle 520 and first vertical angle 522, respectively. The amount of change is directly proportional to the change in distance, and in some instances the size of the display 312 of the display device 212 and/or distances the display device is to the object of interest 214.

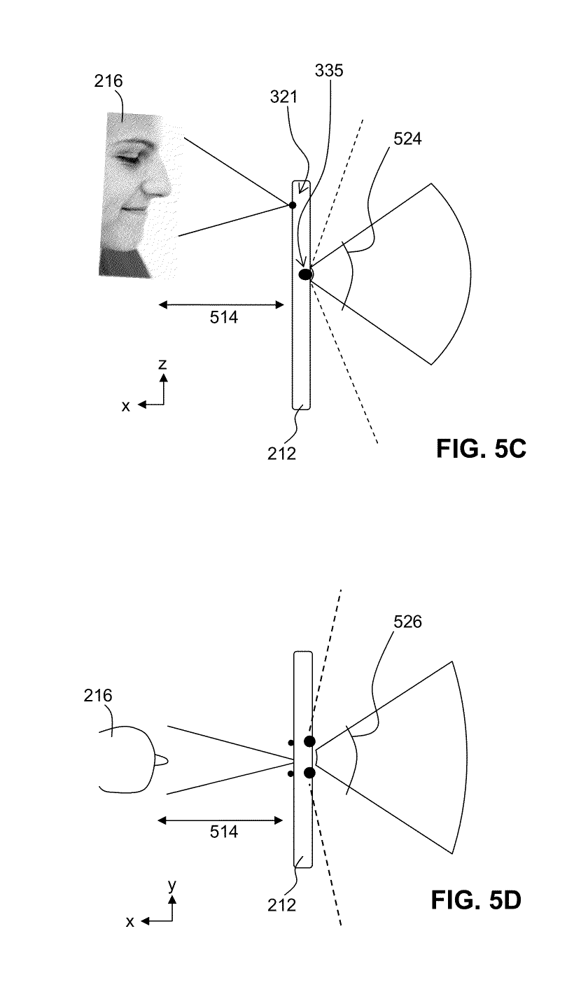

FIG. 6 shows a simplified perspective view of a back side 314 of a display device 212 in accordance with some embodiments. Again, the display device can include two or more forward cameras 334-335 (e.g., stereo cameras). Each forward camera used to capture the stereo images uses a relatively wide angle providing wide fields of view 620-621. A subset or portion of the wide angle images are presented to the user 216 in response to determining the user's orientation (e.g., vertical and horizontal head angles, and distance 512) to the display device 212.

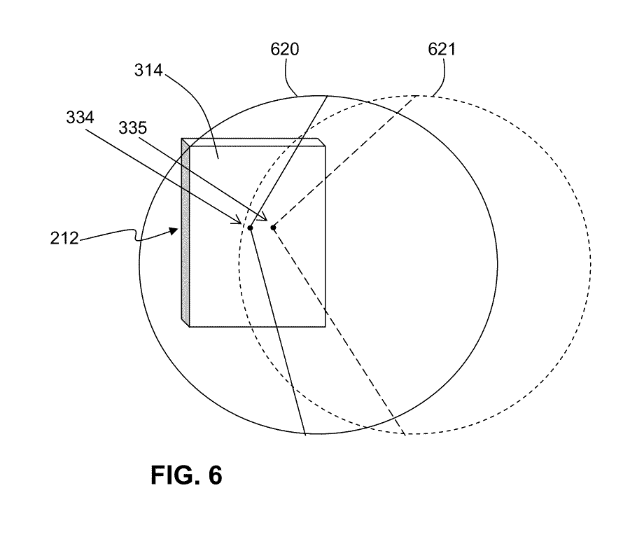

FIG. 7 shows a simplified representation, corresponding with one of the forward cameras 335, of a portion or subset 712 of a field of view 621 that is selected based on the determined orientation of the user 216 relative to the display device 212. Using the selected portion 712 the display device 212 can display a corresponding portion of the images from the video captured by the forward cameras 334-335.

In tracking the orientation of the user 216 relative to the display device 212, the display device 212 may generally track the user's body or the head of the user. In other instances, the display device may additionally or alternatively track the eyes of a user, and use that information in determining the angles to select from the camera input in displaying the portions or subsets of the captured video images. When determining the orientation the display device is concerned with distances from the user to the display device. Accordingly, some embodiments set a maximum distance, which could be 3-5 feet, one meter or some other distance, which can depend on the display device and the use of the display device. In many instances, the display device is a hand-held device, and accordingly the distance between the user and the display device is typically limited by a user's arm length. Accordingly, a maximum distance threshold of 3-4 feet is often reasonable. Some embodiments further consider or apply a minimum distance between the user and the display device 212 (e.g., the user's eyes are one to two inches from the display device).

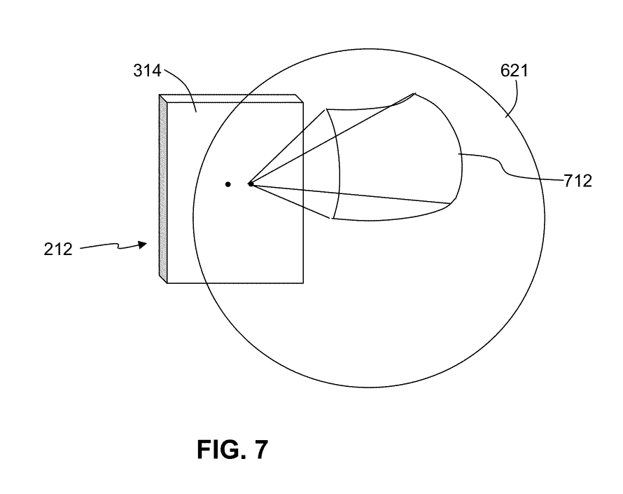

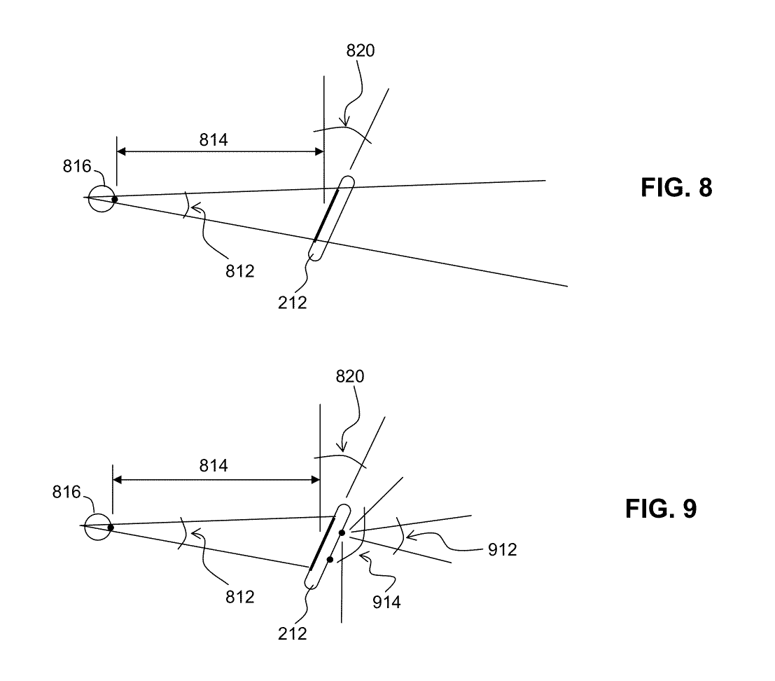

In determining and tracking the orientation of the user relative to the display device, some embodiments take advantage of the linear relationship between the angle to use and the distance from the user's head to the display device. FIGS. 8-9 depict simplified graphical representations of parameters used in determining a user's orientation, in accordance with some embodiments. An initial angle 812 can be calculated for the user, the user's head, the user's eyes or the like. As described above, the one or more display side cameras 320-321 can be used to detect the user and to calculate the user's orientation relative to the display device. In some instances, for example, the initial angle 812 can be calculated in radians for one or both eyes based on a distance 814 between the user's eye 816 and the display device 212 (e.g., a central point of the display 312). A correction angle 820 (typically both horizontal and vertical) cal also be calculated (e.g., in radians) based on the orientation of the display device 212 to the user's face and/or eyes. From these parameters the display device 212 can define final angle 912 that defines the subset or portion of the camera imagery to present on the display 312 of the display device relative to the user's orientation.

Again, some embodiments set maximum and minimum distance thresholds. When the user or user's eyes 816 are at or beyond the maximum distance, the display device 212, in some embodiments, set the initial angle 812 to a predetermined minimum value. When the user's eye 816 is within the minimum distance, the display device in some embodiments sets the initial angle 812 to match the maximum wide angle field of view 420 obtained from the forward cameras 234-235 used to collect the video or scene data.

Referring to FIG. 9, for both horizontal and vertical orientations the display device 212 can find a final angle 912 by multiplying the initial angle 812 by the cosine of the correction angle 820. Accordingly, the final angle 912 used to define the portion of the captured image to be displayed is both reduced from the initial angle 812 and oriented by the correction angle 820. When the correction angle is zero then the initial angle 812 is used. As the display device 212 tilts relative to the user's view, the correction angle 820 reduces the amount of the scene 914 (i.e., the angle of the entire scene captured by the forward cameras) to be displayed and selects what portion of the scene to retrieve. As can be seen in FIG. 9, the final angle 912 is a portion of the angel of the entire scene 914 (the field of view of the forward cameras 334-335). The correction angle 820 rotates the portion or subset of the camera input to be displayed to match the angle or tilt of the display device 212 relative to the user's position.

Other methods of identifying a user's orientation and/or tracking a user or user's eyes can be employed. For example, the user may wear objects that allow for easier tracking and/or the object being worn may provide information, such as 3D glasses or goggles (typically battery powered). Information from the glasses or other device may be communicated via wired or wireless communication (e.g., radio frequency, light emitting, or other such technique). Additionally or alternatively, the glasses or other device may have passive structures (e.g., reflective patches or patterns) that can be targeted, for example, through image processing. In capturing information, visible light and/or Infrared may be used. Similarly, one or more cameras on the display device, glasses or the like may be used. In tracking, one or more algorithms may be used, such as with image processing, and these may be feature based, intensity based, and the like or combinations thereof. Some embodiments may employ automatic calibration, manual calibration, combination of automatic and manual calibration, while other embodiments and/or aspects of calculations my not use or need calibration (e.g., predetermined and/or assumed specifications).

In many applications, the least demanding method (to the user 216) avoids any apparatus that is worn by the user, and typically employs methods involving image processing. Some embodiments attempt to simplify the display device 2122 and/or processing at the display device. Accordingly, some embodiments minimize the image capture hardware and/or processing. For example, in some embodiments a single visible light display side camera 320 is used. Other embodiments may additionally or alternatively use one or more IR cameras, which often would be cooperated with one or more corresponding IR light sources.

When using facial tracking algorithms against the captured images, the position and orientation of the user's eyes can be determined within a defined space or region. The space defined by the algorithms is often unitless (e.g., because it is based on the pixels within the image stream). To translate that space into the 3D volume between the display device 212 and the user 216, calculations are performed. This calibration can include some basic geometric information. The angle between pixels is stable and based on the known optics of the capture device (e.g., display side camera 320). Further, some calibration can be implemented by providing two or more known distances within a feature of the captured image. For example, a half-circle protractor could be used since the distance between the ends would be known and from each end to the peak of its half circle. With these distances and angles the algorithms abstract spatial coordinates can be transformed into real values relative to the camera 320 and/or display 312.

Referring back to FIG. 2B, while displaying the portion of the captured images, the display device 212 can be configured to display additionally information 222 relevant to the object of interest 214. Typically, the display device 212 in displaying the information 222 displays it in such a way that it does not interfere with the view of the object of interest 214. Still further, in some instances, the additional information 222 is displayed in such a way to identify that the information is relevant to the object of interest 214 and not a different object (e.g., placement, proximity, led line, call out, color, or the like or combinations thereof). It is noted that the display device 212 in playing back the relevant portion of the video captured by the forward cameras 334-335 may display more than one potential object of interest. Further, in some instances, information relevant to more than one object of interest may simultaneously be displayed. A user may be able to select or otherwise identify one of the devices of interest.

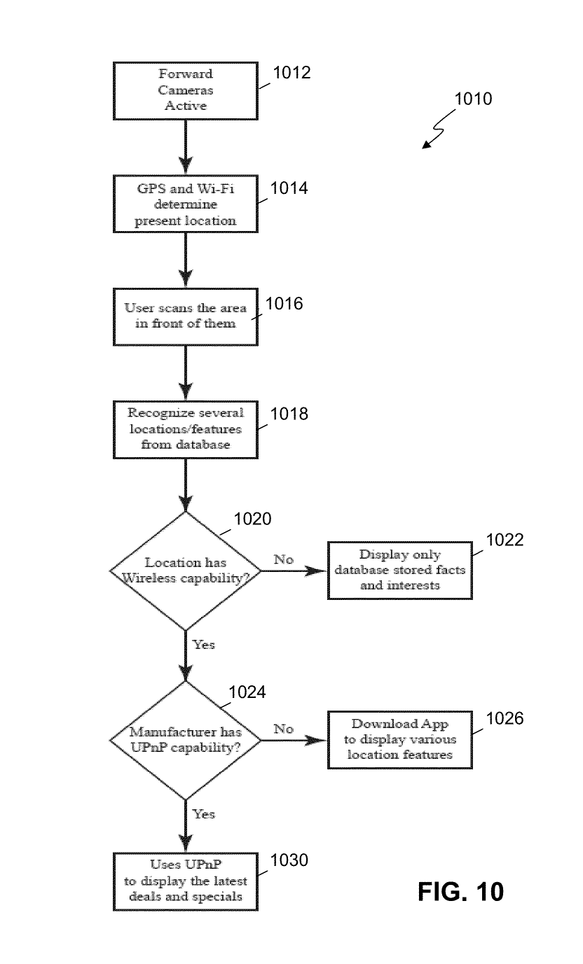

FIG. 10 depicts a simplified flow diagram of a process 1010 in providing additional information 222 relevant to an object of interest 214, according to some embodiments. In step 1012, the one or more forward cameras 334-335 are activated and/or are maintained as active. Some embodiments include step 1014, where additional information may be considered in attempts to identify an object of interest 214 and/or identify information that might be relevant and/or of interest. This additional information can include, but is not limited to, GPS information, wirelessly received information (e.g., received via WiFi, such as from an object of interest 214), accelerometer information, compass information, information from a source related to an object of interest, and/or other such information. The information may be based on information locally stored on the display device 212 or remotely stored (e.g., through the display device accessing a remote source or database over the Internet). In some instances, the information is maintained in one or more databases that can be accessed by the display device 212 or other device(s) or service(s) accessed by the display device and the information used by the display device.

In step 1016, that forward cameras 334-335 capture video. For example, the user 216 may scan an area in front of the user. In step 1018, the display device 212 recognizes one or more objects of interest, locations and/or features of objects of interest that allow the display device 212 to recognize the object of interest 214. In some embodiments, one or more separate devices and/or services may be accessed by the display device to help in identifying one or more objects of interest and/or obtaining additional information corresponding to the one or more objects of interest. In step 1020, the display device 212 determines whether it has the capability to communicate with one or more devices (e.g., via the internet, WiFi, local area network, Infrared, RF, etc.). For example, the display device 212 can determine whether it has access to the Internet to acquire additional information regarding a potential object of interest 214. In other instances, the display device 212 may communicate with an object of interest (e.g., a TV) or a device associated with the object of interest (e.g., a set-top-box) to acquire additional information.

In those instances where the display device 212 cannot access information from an additional source, step 1022 is entered where the objects of interest identified by the display device 212 and/or the additional information 222 displayed by the display device 212 is limited to information locally stored by the display device. Alternatively, when the display device 212 has access to other sources, the process 1010 continues to step 1024 to determine the display device can communicate with an object of interest 214. For example, it can be determined whether the object of interest has Universal Plug and Play (UPnP) capabilities. In those instances where the display device 212 cannot communicate with the object of interest (e.g., UPnP is not available or communication cannot be established) some embodiments provide step 1026 where the display device 212 can access a source to download an application, software, executable or the like that can provide the display device 212 with features (e.g., download an application to display various location features). The application can be downloaded from substantially any relevant application source or “store,” which may be dependent upon an appropriate operating system. When a UPnP or other communication is available step 1030 can be entered where relevant information can be obtained and displayed by the display device 212 (e.g., latest deals and specials), and typically displayed while displaying captured video of the object of interest 214. For example, the object of interest 214 may expose an API over a local area network that can be detected and used by an application on the display device 212.

Some embodiments provide a platform that enables application developers to take advantage of the feature provided through the platform. For example, the platform provides image processing (e.g., user orientation, facial recognition, device (image) recognition, etc. Accordingly, application providers would define, within the application, parameters that the display device 212 should acquire for recognizing the object of interest 214 (e.g., if a TV manufacturer generates an application that can define, within the local area network exposed application, the parameters that can be used by the application and/or the display device 212 to recognize the TV as a device to be controlled through the application being implemented by the display device 212).

Further, the platform provide position and/or spatial data of where the object of interest 214 is within the “view” of the user relative to the display device 212, accordingly the application does not have to provide this functionality, but instead, can use this provided functionality. For example, the application can use the spatial data to accurately display, within the virtual world, the additional information 222 relative to the object of interest when displayed from the captured video, and which typically is displayed in 3D. Again, the object of interest when displayed by the display device is not an animation but actual images of the object of interest, which can be displayed in 3D.

Further, the platform provides the application with various levels of interaction, such as touch screen feedback (e.g., provide the touch screen feedback information to the application, which can use the information in determining how to adjust the additional information 222 that is displayed and/or communicate commands or control information to the object of interest 214 (e.g., adjust volume)). Similarly, the platform provides the user tracking and/or user orientation information, as well as determining how to adjust the display content relative to the user's orientation.

As described above, there may be multiple objects of interest. Further, the display device may capture images of one or more objects of interest and/or capture images (e.g., video) that simultaneously include multiple objects of interest. In some embodiments, the display device 212 can identify or help to identify objects of interest. Further, a remote device or service may help in identifying one or more objects of interest, and/or providing additional information corresponding to the one or more objects of interest.

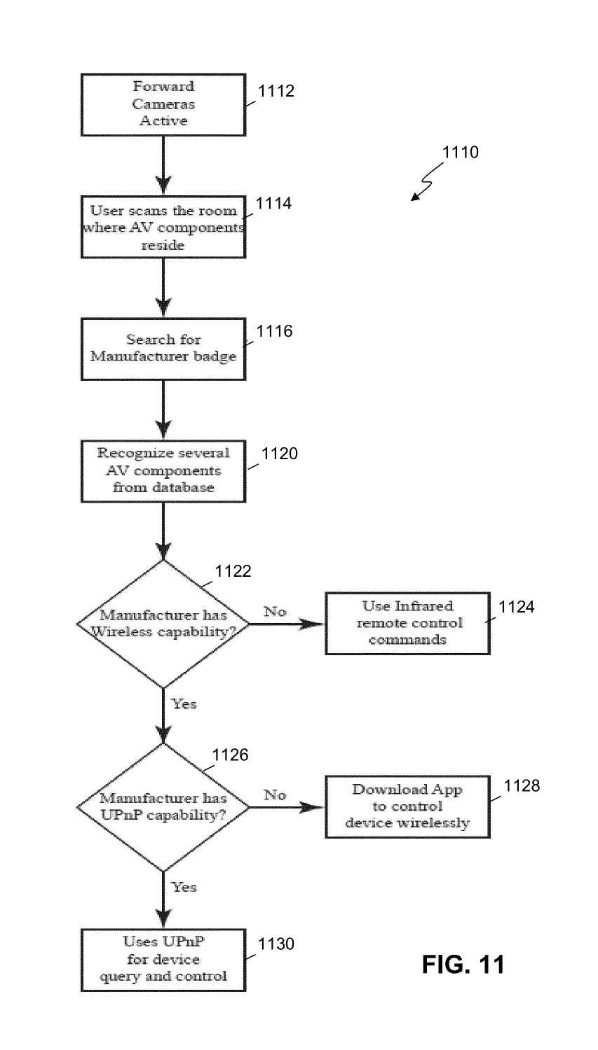

FIG. 11 depicts a simplified flow diagram of a process 1110 of recognizing an object of interest 214 and providing interaction with the object of interest in accordance with some embodiments. For example, when the object of interest 214 is an audio/video (A/V) playback device (e.g., a TV), the process 1110 may allow a user to control the object of interest through the display device 212. In step 1112, the one or more forward cameras 334-335 are activated and/or are maintained as active. In step 1114, that forward cameras 334-335 capture video. For example, the user 216 may aim the forward cameras at one or more potential objects of interest, scan an area in front of the user or other such action. In step 1116, the display device 212 evaluates captured images from the forward cameras in attempts to identify objects and/or aspects of objects that might be objects of interest 214. For example, the display device may search local and/or remote databases based on shapes of objects, shapes of aspects of objects, symbols, alphanumerical characters, spacing and/or relative orientation of potentially distinguishing features (e.g., button locations and/or orientation, port locations, facial anatomy (e.g., eyes, mouth, nose location and/or orientation, etc.) and the like), and/or other such information. Similarly, some embodiments may also consider current location, locations and/or features of potential objects of interest, or other such information that might be used by the display device 212 to recognizing an object of interest 214. In step 1120, an object of interest 214 is detected. In some instances, multiple potential objects of interest may be recognized. Further, a single one of these multiple objects may be selected by the display device 212 and/or the user 216.

Still further, some embodiments, similar to that described above may consider GPS information, wirelessly received information (e.g., received via WiFi, such as from an object of interest 214), accelerometer information, compass information, information from a source related to an object of interest, and/or other such information. The information may be based on information locally stored on the display device 212 or remotely stored (e.g., through the display device accessing a remote source or database over the Internet). In some instances, the information is maintained in one or more databases that can be accessed by the display device 212 or another device accessed by the display device and the information used by the display device.

In step 1122, the display device 212 determines whether the object of interest 214 is configured to establish wireless communication with the display device 212. In those instances where communication cannot be established, some embodiments may include step 1124 where the display device 212 may allow a user to use the display device as a remote control to the object of interest (e.g., through Infrared (IR) remote control commands information with both devices have the relevant capabilities and correct corresponding commands). In some instances, the IR commands or codes may be locally stored and/or updated (e.g., from a remote database on a regular basis). Alternatively, when wireless communication can be established the process 1110 continues to step 1126 where the display device 212 determines whether the object or device of interest has UPnP capabilities or other similar capabilities. In those instances where UPnP is not available, step 1128 may be entered to download an application or code that would allow the user 216 to utilize the display device 212 in controlling the object of interest 214. One UPnP can be established, step 1130 is entered where the display device 212 uses the UPnP to query and control the object of interest 214.

In many embodiments, the recognition by the display device 212 of the object of interest 214 is based on information defined within the application providing the additional information 222, obtained from a local or remote database or the like. In some instances, the display device 212, the application operating on the display device and/or the relevant database can be updated with information that can be used in identifying additional objects of interest. For example, additional data files for adding new objects of interest (e.g., manufacturers' equipment) can be added through an application source (e.g., an application store or source associated with the display device 212). In some instances, the display device 212 can store or have access to a base set of recognition data files. These recognition data files can be controlled and/or updated by the display device manufacturer, display device distributor, objects of interest manufacturers, or the like. Further, in some embodiments, the recognition data files may be changed, replaced and/or updated by software updates to the display device.

Further, some embodiments provide mechanisms of coordinating, for example, the data shown on an augmenting display device 212 and consumer electronics devices (e.g., BD players, Televisions, Audio systems, game consoles and such). When queried the object of interest 214 or other source associated with the object of interest can provide information, which may enhanced the user experience, to the display device 212 that can be shown as augmented reality data on the display 312 of the display device 2121. As an example, looking through the augmenting display device 212 at a TV, the display device 212 can display information (e.g., a film strip like display) showing what programming (e.g., TV show, movies, sports, etc.) will be shown on that current or different TV channel later that day. The additional information can be shown so that it does not interfere with the content being played back on the TV (e.g., floating above or to the side of the TV, which may be dependent on the relative orientation of the display device 212 relative to the object of interest), which can avoid having to cover up or remove the video that is playing on the TV with some other on screen, graphics or video. Other systems have tried to address the covering up halting of the TV content by presenting as an overlay that is partially transparent, resizing the video to make is smaller or other such effects that may adversely affect a user's experience. Alternatively, the present embodiments may display the additional information so that it does not obscure the video being played on the TV. Multiple cameras on the display device 212 may be used to provide stereoscopic images and/or to display a 3D representation. Still further, other systems that may provide user information do not take into consider the orientation of the user and/or the orientation of the display device relative to a user's orientation.

Some embodiments, however, mechanisms to use an area on the display screen that is “outside” of an area on a displayed image that includes the object of interest to display information relevant to the object or device of interest (e.g., what is being shown on the TV). The video on the TV screen remains full screen and is not overlaid with graphics. The additional information can be displayed to appear in an augmented reality display 312 of the display device 212 as being outside the viewing area of the TV screen itself The present embodiments can provide ways of providing this information to augmented display devices so they can acutely display the additional information relative to the object of interest and know or can calculate how to display the information relative to the object of interest. Further, because the display device 212 can be configured to or provided with information to display the additional information 222, the additional information 222 can be displayed to appear outside of the TV panel and the video being shown does not have to be obscured, overlaid or resized.

Further, some embodiments can be configured to track an orientation of the user 216 relative to the display device 212 (e.g., using head or eye tracking) to accurately display at least portions of captured images and give the impression the user is “looking through” the display device to what is on the other side. The stereo image on the display 312 of the display device recreates what the user would see if the display device was not there. In some instances, the display device 212 may be a transparent LCD or other device that allows the user to actually look through the display while continuing to track the user's orientation relative to the display device 212 in identifying relevant additional information 222, how that relevant additional information is to be displayed relative to what the user sees through the display device 212 and/or the orientation of the additional information. Additionally, the application activated on the display device 212 configured to display the additional information relative to the object of interest can be configured to request or control the display device 212 such that the video images captured by the forward cameras are not displayed while displaying the additional information, such that the user can see through the transparent LCD while viewing the additional information. In many instances, once the application providing the additional information 222 is terminated, no longer has primary control and/or is not a focused application (e.g., operating, but operating in the background), the display device 212 can continue to display what ever relevant information, images, video or other information that is relevant to the application of focus. In some embodiments, a portion of the transparent display may remain transparent with additional information 222 being displayed, while another portion of the display may be dedicated to an alternate application (e.g., an internet browser application).

Similarly, when the display device 212 does not have a transparent display, the application of focus that is providing the additional information 222 can instruct the display device to stop displaying the video images captured by the forward cameras and/or temporarily stop displaying the images captured by the forward cameras (e.g., an application running on the display device 212 may request that the drawing of the video background be halted while the application is running regardless of whether a backplate or backlight is on the display device or not). When that application loses focus or exits, the display device 212 can resume normal device operation.

Because of the alignment of the display device relative to the real environment, some embodiments further allow the placement of tags (non-interactive) and interactive options over displayed items of the real world. For example, the display device 212 can be configured to display an album cover above an A/V receiver as a song is being played from the A/V receiver. As another example, the display device 212 could be configured to additionally or alternatively show a video of the artist performing the song floating above the A/V receiver. Similarly, additional information 222 can appear above a game console (e.g., remaining HD space, what game is being played back or is available, promotional information (e.g., about for new games) and other such information). The display device 212 could similarly show visual representation of how audio between the speakers has been balanced relative to an A/V receiver, a red X could be displayed as additional information 222 and displayed over speakers in the captured images that are broken, not working properly, and the like. Some embodiments are configured to provide a standardized method for a consumer electronics device to describe to substantially augmented reality device what data it has available to display and how to display that data to the user.

The present embodiments can provide numerous implementations and applications. Below are just examples of implementation of some embodiments. The additional information, which can be substantially any information (e.g., images, text, graphics, tables, and the like, including menus or other controls) relative to an object of interest 214, can be displayed by the display device 212, and generally shown in association with images captured by the display device that include the object of interest (e.g., information about the object the display device is directed, aimed, aligned or pointed at). The additional information 222, may allow a user to implement control over the object or device of interest 214, for example, by interacting with one or more displayed virtual menus through a touch screen display 312 on the display device 212. The display device 212 can be used for home automation to, for example, turn lights on or off, see how much electricity a device is using, change the thermostat level, etc. Similarly, the display device 212 could be linked with automotive, such as when the object of interest is a user's car (e.g., directing the display device at a car to capture video or images of the car), and the display device can display information about the car or maintenance relative to the car (e.g., when the next oil or transmission fluid change is needed), etc. As another example, in a home environment the display device 212 can display speaker balance in the room as a 3D virtual shape that a user can walk through. In some instances, TV channel guide can be displayed (e.g., float above the TV screen) so the video on the TV is not obscured. A user can select items from the displayed guide virtually displayed floating above the TV through the touch screen display 312 of the display device 212. The TV can respond to commands implemented at the display device 212 (e.g., change to selected channel, input, streaming video or other video source).

Similarly, the display device 212 can display an album, image of an artist, lyrics, and/or other such information in the captured image or video with the additional information 222 floating above an AV receiver when music or a radio station is on. By interacting with the display device (e.g., through a user interface, touch screen and the like), a user can connect and route devices on a local area network, home network, or the like, for example, by the display device 212 displaying virtual wireless data signal coverage as 3D shapes a user can follow, walk along and/or walk through. Additionally, information 222 can be provided for telephones (e.g., display device 212 displaying an identification of a caller and/or phone number floating above the phone when the phone is ringing).

As another example, by pointing the display device 212 at a football, the display device may recognize the football, associate that with multimedia content and display information 222 corresponding to multimedia content associated with football (e.g., displaying information about TV programs about sports, which are displayed on the displayed image or video that includes the football). The additional information 222 can include closed captioning information or other information for handicapped users.

Further, the additional information 222 can be associated with home improvements, automobile maintenance, hobbies, assembly instructions and other such educational information. For example, the display device 212 can virtually include a piece of furniture, change colors of walls, show tiling on the floor before the furniture, painting, tiling or other work is actually performed. Recommendations may also be provided based on image processing, user selections or interactions, and/or other relevant information (e.g., providing a wine pairing based on a recipe, color of furniture based on wall color, a paint color based on selected furniture, etc.). By cooperating the display device with CAD model and/or other relevant information or programming, the display device 212 can virtually show wiring, plumbing, framing and the like inside the walls of a home, office, factory, etc. as though the user could see through the walls.

In a consumer application, the display device can virtually display prices of products floating proximate to the displayed products as a user moves through a store. Similarly, the display device 212 can virtually display information 222 about objects and people floating near the displayed object or person. For example, someone's name may be displayed within the image or video, such as above the person's head in the display. This information may be limited, for example, to when a person has authorized the data to be public, otherwise it may not be shown. Similarly, the display device 212 may employ facial recognition functionality or can forward images to a remote source that can perform facial recognition in order to identify the person prior to the additional information 222 being added to the image or video of the displayed person.

As another example application, at theme parks, the display device 212 can display a virtual character that can only be seen through the display device. Additionally, the display device 212 may allow the user to interact with the virtual character, such that the virtual character is not just a static figure. Similarly, the display device 212 may allow for virtual scavenger hunt games with geo-caching. Maps can be displayed, and/or virtual guide lines could be displayed as though on the ground for how to get somewhere while walking Similarly, the mapping or virtual guide lines could be used in theme parks to guide guests to the ride with the shortest line, industrial parks to get visitors to desired destination and other such virtual directions.

Some embodiments provide medical applications. For example, the display device can be used to obtain a patient's medical records (e.g., through facial recognition, recognition of patients name, etc.). Directions for mediation and/or warnings for medication can be provided. For example, a user can capture video of a prescription bottle and the display device can recognize the prescription (e.g., through bar code detection, text recognition, etc.) and display information about the prescription (e.g., side effects, use, recommended dosage, other medications that should not be combined with the identified medication, etc.).

Accordingly, the present embodiments provide a framework, platform or environment that allows applications takes advantages of the attributes of the display device 212 to provide users with additional information relevant to an object of interest. Applications can be prepared to utilize the environment for given objects of interest or give information. Substantially any source can generate these applications to take advantage of the environment provided through the present embodiments to utilize the features of the display device. In many embodiments, the applications do not have to incorporate the capabilities of user tracking, image or video capturing, video segment selection, or the processing associated with the features. Instead, these applications can be simplified to take advantage of these features provided by the display device 212 or one or more other applications operating on the display device.

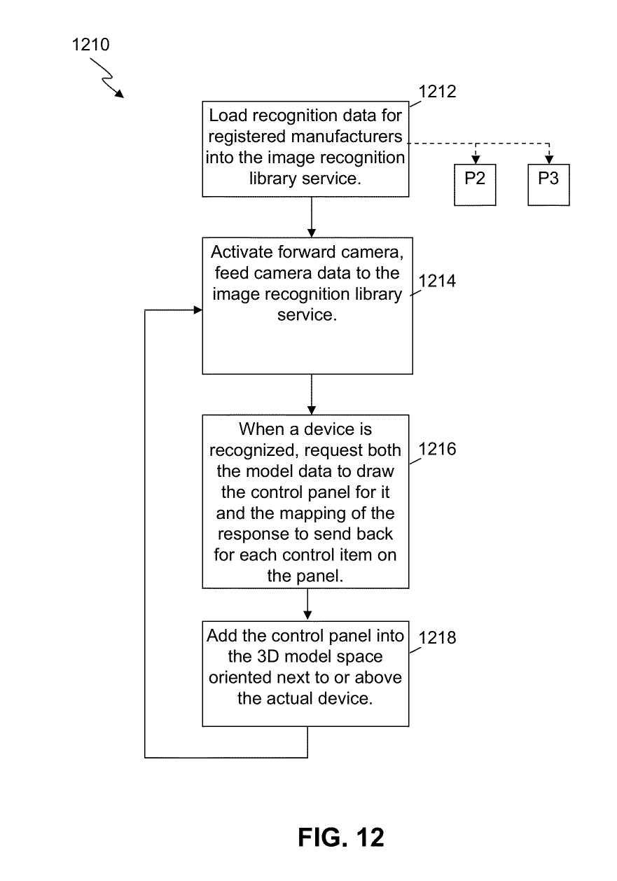

FIG. 12 depicts a simplified flow diagram of a process 1210 of displaying on a display device 212 additional information 222 that corresponds to an object of interest 214, in accordance with some embodiments. In some implementations, the process 1210 can be activated in response to activating a relevant program or application on the display device 212 to display the additional information as described above and further below. Additionally or alternatively, the process 1210 can be activated in response to the display device 212 being activated (e.g., during a boot up processes or in response to or following a system booting up). Further, the process 1210 can active one or more other processes and/or operate in cooperation with one or more other processes that may be implemented before, after or while the process 1210 is in progress. The process 1210 is described below relative to the additional information 222 being a control panel that is displayed by the display device 212, where the control pane, for example, allows a user to control an object of interest 214 (e.g., controlling a television).

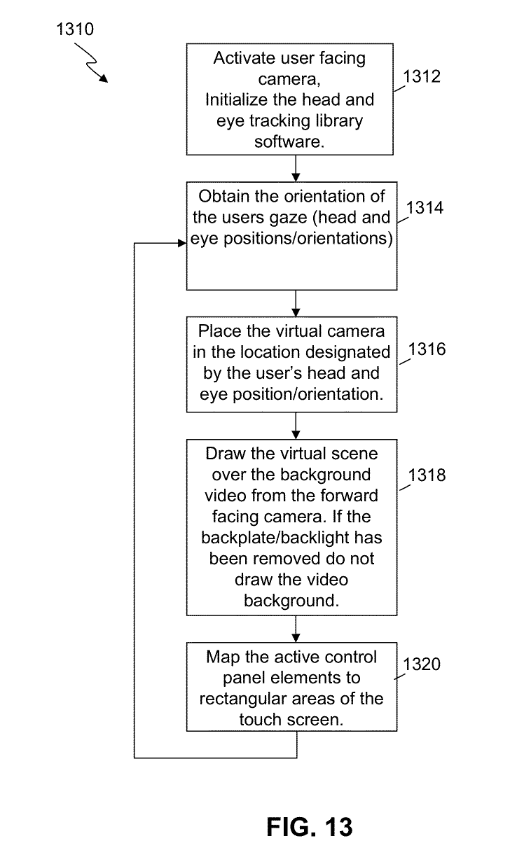

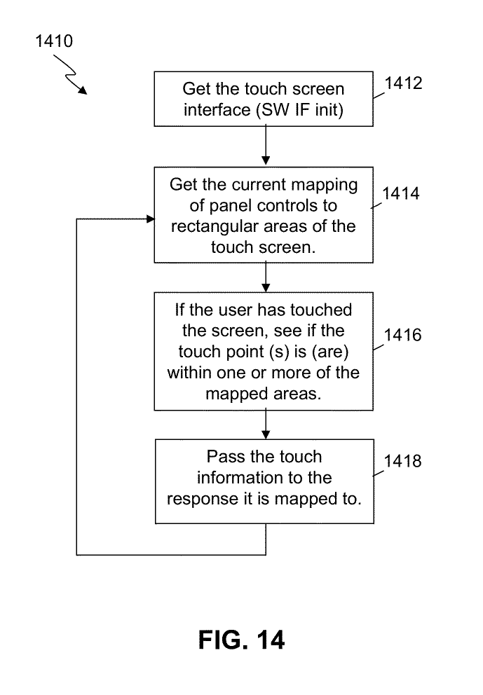

In step 1212, recognition data for one or more objects of interest can be loaded. For example, recognition data for registered manufacturers and/or services of objects of interest can be loaded into an image recognition library application or service. As described above, in some instances, the process 1210 can cooperate with one or more other processes (P2, P3), such as processes 1310 and 1410 described below with reference to FIGS. 13-14. In step 1214, the one or more forward cameras 334-335 of the display device 212 are activated to capture video and/or images. The camera data can be forwarded to an image recognition library service or application. In some instances, this can include some or all of the process 1010 of FIG. 10 and/or process 1110 of FIG. 11.

In step 1216, information, parameters and the like are obtained to display the additional information 222 corresponding to the detected object of interest 214 when an object of interest is recognized. For example, when the additional information is a control panel that can be used by a user to control the object of interest 214 (e.g., a user interface that can allow a user to select control options from the user interface), the information obtained can include model data to display or draw the control panel and mapping information of the responses, control information and/or signals for each control item of the control panel that can be communicated to the object of interest to implement desired control operations at the object of interest. Again, the recognition data loaded into an image recognition library application or service (e.g., for registered manufacturers, and/or services of objects of interest, images of objects, dimensions of objects, recognizable features and/or relative orientation of features, and the like) can be used to identify the one or more objects of interest. When multiple potential objects of interest are detected the display device can request the user select one of the devices of interest, the display device may select one of the devices (e.g., based on past user actions, most relevant, most recently used, etc), additional information may be displayed for one or more of the objects of interest, or the like.

In step 1218, the additional information 222, in this example a control panel, is configured relative to what is being displayed on the display device 212, and the control panel is displayed into the virtual 3D model space oriented next to, above or other orientation relative to the object of interest 214. In determining the orientation to display the control panel, the process can take into consideration whether the control panel is overlapping the object of interest, overlapping other additional information corresponding to another object of interest, overlapping another object of interest, or the like. In such cases, the process 1210 can reposition, reorient, reformat or take other action relative to the control panel (and/or other additional information associated with other objects of interest) attempting to be displayed. In some instances, such as when a position for the control panel cannot be found that does not overlap, the display device may prompt the user to rotate to display device 212 (e.g., from a landscape orientation to a portrait orientation). In some instances, the process 1210 may return to step 1214 to continue to capture video and/or images from the forward cameras.

FIG. 13 depicts a simplified flow diagram of a process 1310 of detecting an orientation of a user 216 relative to the display device 212 in accordance with some embodiments. Again, this process 1310 can be utilized in cooperation with the process 1210 of FIG. 12 and/or other processes. In step 1312, one or more display side cameras 320-321 (typically oriented toward the user when the user is viewing the display 312) are activated. A head and/or eye tracking library, software and/or application can be activated to detect and track the relative position of the user. In step 1314, the display device receives video and/or images from the one or more display side cameras, processes those video and/or images relative to the tracking library to obtain an orientation of the users gaze (e.g., head and eye positions/orientations and/or angles), as described above, such as with respect to FIGS. 4A-9.

In step 1316, the viewing angles and/or portions 412-417 of the images captured by the forward cameras 334-335 are determined. In some instances, the identification of the portions of the captured images to be displayed can be similar to identifying an orientation of a virtual camera and a virtual position identified through the user's head and/or eye position and/or orientation relative to the display device 212. In step 1318, the additional information 222 is generated or drawn to be displayed in cooperation with the portions of the images captured by the forward cameras determined to be displayed. In some instances, the displaying of the additional information is similar to animating or drawing a virtual scene (e.g., the additional information obtained from the process 1210) over the portion of the background video displayed from the one or more forward cameras 334, 335. Additionally, as described above with some embodiments, the display device may have a transparent display 312. With these types of display devices, when a backplate and/or backlight has been removed relative to the transparent display the additional information 222 can be displayed in an identified orientation while the display device does not display the background video captured by the forward cameras. In step 1320 the control panel elements (or other additional information) are mapped to the display 312 of the display device 212 and/or mapped to rectangular areas of a touch screen. For example, the interactive portions of the control panel are mapped to the touch screen such that the display device 212 can detect the user's touch and identify which of the control elements the user is attempting to activate. Again, the control elements of the control panel can depend on the object of interest 214, the capabilities of the object of interest, the capabilities of the display device, a user's authorization, a user's access level and/or other such factors. The process 1310 may, in some instances, return to step 1314 to continue tracking the orientation of the user 216 relative to the display device 212.

FIG. 14 shows a simplified flow diagram of a process 1410 of allowing a user 216 to interact with the display device 212 and/or the additional information (e.g., the control panel of additional information) being displayed in association with the identified object of interest 214, in accordance with some embodiments. The process 1410 typically is implemented in cooperation with other processes, including the process 1310 of FIG. 13. In step 1412, the touch screen display 312 is activated. In step 1414, the current mapping of panel controls to rectangular areas of the touch screen generated in the process 1310 are accessed.

In step 1414, an orientation of a user's touch on the touch screen is identified and a corresponding control element mapped is identified when the location the user touched is mapped to a control element. In step 1416, the touch information (e.g., number of times touched, dragging, pinching, etc) is forwarded to the response of the mapped control element or elements. The response identifies relevant actions based on the touch information and initiates and/or takes appropriate action. The control element respond can, for example, make a call to request for updated or new model data for the control panel, start media playback, send a control command to the object of interest 214 (e.g., change the TV channel), or substantially any relevant action or actions as determined by the response map provided. The process 1410 may, in some instances, return to step 1414 to await further user interaction with the touch screen.

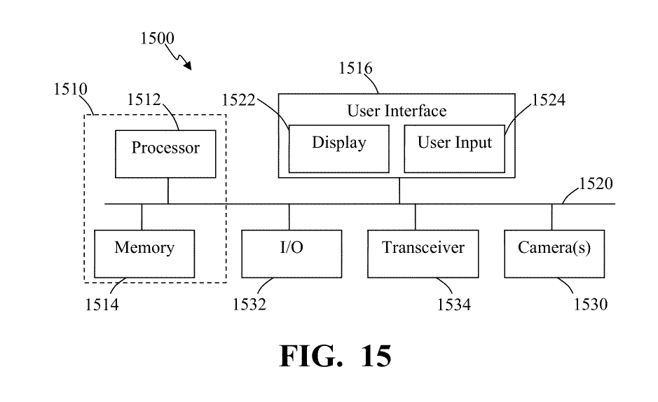

The methods, techniques, systems, devices, services, servers, sources and the like described herein may be utilized, implemented and/or run on many different types of devices and/or systems. Referring to FIG. 15, there is illustrated a system 1500 that may be used for any such implementations, in accordance with some embodiments. One or more components of the system 1500 may be used for implementing any system, apparatus or device mentioned above or below, or parts of such systems, apparatuses or devices, such as for example any of the above or below mentioned display devices 212, objects of interest 214, cameras 320-321, 334-335, displays 312, content source, image processing system, device detection, user orientation tracking and the like. However, the use of the system 1500 or any portion thereof is certainly not required.

By way of example, the system 1500 may comprise a controller 1510, a user interface 1516, and one or more communication links, paths, buses or the like 1520. A power source or supply (not shown) is included or coupled with the system 1500. Some embodiments further include one or more cameras 1530, input/output ports or interfaces 1532, one or more communication interfaces, ports, transceivers 1534, and/or other such components. The controller 1510 can be implemented through the one or more processors 1512, microprocessors, central processing unit, logic, memory 1514, local digital storage, firmware and/or other control hardware and/or software, and may be used to execute or assist in executing the steps of the methods and techniques described herein, and control various communications, programs, content, listings, services, interfaces, etc. The user interface 1516 can allow a user to interact with the system 1500 and receive information through the system. The user interface 1516 includes a display 1522, and in some instances one or more user inputs 1524, such as a remote control, keyboard, mouse, track ball, game controller, buttons, touch screen, etc., which can be part of or wired or wirelessly coupled with the system 1500.

One or more communication transceivers 1534 allow the system 1500 to communication over a distributed network, a local network, the Internet, communication link 1520, other networks or communication channels with other devices and/or other such communications. Further the transceiver 1534 can be configured for wired, wireless, optical, fiber optical cable or other such communication configurations or combinations of such communications. The I/O ports can allow the system 1500 to couple with other components, sensors, peripheral devices and the like.

The system 1500 comprises an example of a control and/or processor-based system with the controller 1510. Again, the controller 1510 can be implemented through one or more processors, controllers, central processing units, logic, software and the like. Further, in some implementations the processor 1512 may provide multiprocessor functionality.

The memory 1514, which can be accessed by the processor 1512, typically includes one or more processor readable and/or computer readable media accessed by at least the processor 1512, and can include volatile and/or nonvolatile media, such as RAM, ROM, EEPROM, flash memory and/or other memory technology. Further, the memory 1514 is shown as internal to the system 1500 and internal to the controller 1510; however, the memory 1514 can be internal, external or a combination of internal and external memory. Similarly, some or all of the memory 1514 can be internal to the processor 1512. The external memory can be substantially any relevant memory such as, but not limited to, one or more of flash memory secure digital (SD) card, universal serial bus (USB) stick or drive, other memory cards, hard drive and other such memory or combinations of such memory. The memory 1514 can store code, software, applications, executables, scripts, information, parameters, data, content, multimedia content, coordinate information, 3D virtual environment coordinates, programming, programs, media stream, media files, textual content, identifiers, log or history data, user information and the like.

One or more of the embodiments, methods, processes, approaches, and/or techniques described above or below may be implemented in one or more computer programs executable by a processor-based system. By way of example, such a processor based system may comprise the processor based system 1500, a computer, a tablet, a multimedia player, smart phone, a camera, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques for displaying additional information relevant to an object of interest, and typically displaying captured images or video including an object of interest while virtually displaying additional information relative to the object of interest. As another example, such computer programs may be used for implementing any type of tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium configured to embody a computer program for input to a processor or computer and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: capturing, with one or more cameras of a display device, video along a first direction, the video comprising a series of video images; identifying an object of interest that is captured in the video; obtaining additional information corresponding to the object of interest; identifying an orientation of a user relative to a display of the display device, where the display is oriented opposite to the first direction; determining portions of each of the video images to be displayed on the display based on the identified orientation of the user relative to the display such that the portions of the video images when displayed are configured to appear to the user as though the display device were not positioned between the user and the object of interest; and displaying, through the display device, the portions of video images as they are captured and simultaneously displaying the additional information in cooperation with the object of interest.

Other embodiments provide one or more computer-readable storage mediums storing one or more computer programs configured for use with a computer simulation, the one or more computer programs configured to cause a computer and/or processor based system to execute steps comprising: capturing video images along a first direction; identifying an object of interest that is captured in the video images; obtaining additional information corresponding to the object of interest; identifying an orientation of a user relative to a display; determining portions of each of the video images to be displayed on the display based on the identified orientation of the user relative to the display; and displaying the portions of video images as they are captured and simultaneously displaying the additional information in cooperation with the object of interest.

As described above, some embodiments identify one or more objects of interest that is captured in the video images. In some instances, multiple devices of interest may be identified while additional information 222 provided may be limited to less than all of the potential devices of interest. For example, the additional information provided may be limited to those devices that are capable of providing some or all of the additional information or otherwise directing the display device 212 to a source for additional information. In other instances, some of the devices may be powered off and accordingly the additional information may not be relevant to those powered off devices. In other instances, the display device 212 may provide the user 216 with the ability to select one or more of the potential objects of interest (e.g., by having the user select through the touch screen display 312 the one or more devices of interest, select an object from a listing of potential object, identify object of interest based on user's interactions with the display device 212, voice recognition, previous user history, and the like.

The additional information may be stored on the display device 212, obtained from the object of interest 214, obtained from a remote source (e.g., accessed over the Internet), or other such methods. For example, the display device 212 may access a local area network and identify communications from the object of interest (e.g., based on a header with a device ID. In some instances, the display device 212 may issue a request to the object of interest 214, where in some instances display device might have to know what is being request. In other instances, the display device 212 may issue a request and then the object of interest 214 distributes the additional information 222, for example, based on current conditions, the additional information could include a menu and then the object of interest can respond to menu selections, the object of interest may periodically broadcasts the additional information to be received by a relevant device, or the like. In some instances, the additional information may provide users with option regarding to still further additional information. For example, the object of interest may provide animated elements that when selected provide scores for a game being watched, statistics about the game or player in the game, or the like.

Again, the display device 212 may obtain the additional information 222 from another source besides the object of interest 214. For example, the display device 212 may identify the object of interest (e.g., face recognition; device recognition;

recognize text (e.g., on box of retail product); recognize based on location (e.g., location within store), or the like), and then access a database (whether local or remote, which could depend on the identified object of interest) to acquire additional information. For example, in a retail environment, the display device 212 could identify the object of interest, access a local database to obtain information (e.g., store stock information, pending orders, missing products, coupons, pricing (e.g., pricing per ounce/server/etc.), comparisons, reviews, etc.). Additionally or alternatively, the display device 212 may access a database over the Internet and obtain the additional information 222 (e.g., product information, energy use, coupons, rebates, pricing (e.g., pricing per ounce/server/etc.), comparisons, reviews, etc.). With facial recognition, the display device 212 may use locally stored information, social networking site information, and the like. With mapping and/or street view information, the display device 212 may access a remote source (e.g., Google maps, etc.) to obtain relevant additional information 222.

The display device 212 also typically displays the additional information based on the orientation of the user 216 relative to the display device. Accordingly, the display device can identify an orientation of a user relative to the display 312. This orientation can be based on body, head, eye or other recognition. Similarly, head and/or eye tracking can continuously be updated. The display device 212 uses the one or more display side cameras 320-321, image processing, and calculations to determine relevant portions of images or video captured by the forward cameras 334-335 are to be displayed. With the knowledge of the user orientation, the display device 212 can further display relevant portions of the images or video captured by the forward cameras 334-335. Further, the relevant portions are typically identified so that the displayed portions are displayed by the display device 212 given the appearance that the user 216 is effectively looking through the display device. Further, the display device 212 in some embodiments can display the images and/or video captured by the forward cameras 334-335 and/or the additional information in 3D with relevant orientation based on user's orientation. As such, the additional information may be displayed with spatial positioning and orientation, such as appearing to be projected out in the 3D space. Some embodiments take into consideration, when determining the user's orientation, the user's distance from display device 212 (e.g., x axis), and angle relative to display device (e.g., y and z axes). The identified portions of the images or video captured by the forward cameras 334-336 are typically displayed by the display device 212 in substantially real time as the images or video are captured. Further, the additional information is typically simultaneously displayed with displayed portions of the images or video in cooperation with the object of interest.

Further, the display device can perform image processing of the images or video captured by the forward cameras 334-335 to determine where the additional content is to be displayed. Similarly, the image processing can allow the display device 212 to determine the amount of additional information to display, fonts and other relevant factors based on relevant space where the additional information may be displayed. Further, in some instances, some or all of the additional information may additionally or alternatively be provided by the display device 212 as audio content. In some instances other factors are taken into consideration in identifying the additional information, identifying portions of the images or video to display and/or identifying where within the displayed portions of the images or video the information is to be displayed, such as an orientation of the display device 212, GPS information; accelerometer information; gyroscope information; image processing at the object of interest 214 (e.g., object of interest 214 communicates back to the display device 212), and the like.

Many of the functional units described in this specification have been labeled as devices, system modules and components, in order to more particularly emphasize their implementation independence. For example, a device and/or system may be implemented as a hardware circuit comprising custom VLSI circuits or gate arrays, off-the-shelf semiconductors such as logic chips, transistors, or other discrete components. Devices and systems may also be implemented in programmable hardware devices such as field programmable gate arrays, programmable array logic, programmable logic devices or the like.

Devices and systems may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise a device or system and achieve the stated purpose for the device or system.

Indeed, a device or system of executable code could be a single instruction, or many instructions, and may even be distributed over several different code segments, among different programs, and across several memory devices. Similarly, operational data may be identified and illustrated herein within device or system, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of providing information, comprising:
capturing, with one or more cameras of a display device, video along a first direction, the video comprising a series of video images;
detecting a first object of interest that is captured in the video;
obtaining additional information corresponding to the first object of interest;
determining an orientation of a user relative to a display of the display device, where the display is oriented opposite to the first direction;
determining portions of each of the video images to be displayed on the display based on the determined orientation of the user relative to the display such that the portions of the video images when displayed are configured to appear to the user as though the display device were not positioned between the user and the first object of interest; and
displaying, through the display device, the portions of video images as they are captured and simultaneously displaying the additional information in cooperation with the first object of interest.

2. The method of claim 1, wherein the displaying the portions of the video images comprises three-dimensionally displaying the portions of the video images to appear to the user has having depth consistent with what the user would otherwise see should the display be removed from the user's field of view.

3. The method of claim 2, wherein the displaying the additional information comprises displaying the additional information such that the displayed additional information does not interfere with the user's viewing of the first object of interest.

4. The method of claim 1, further comprising:
detecting interaction from the user corresponding to the first object of interest;
identifying, based on the detected interaction, control information to be communicated to the first object of interest; and
communicating the control information to the first object of interest.

5. The method of claim 4, wherein the detecting the interaction comprises detecting interaction with the displayed additional information.

6. The method of claim 1, wherein the capturing the video along the first direction comprises capturing the video along the first direction corresponding with a direction of a user's field of view when looking at the display device.

7. The method of claim 1, further comprising:
detecting a second object of interest in addition to the first object of interest, where the second object of interest is captured in the video;
obtaining additional information corresponding to the second object of interest;
wherein the displaying the portions of video images comprises displaying the portions of video images as they are captured and simultaneously displaying the additional information corresponding to the first object of interest in cooperation with the first object of interest and displaying the additional information corresponding to the second object of interest and in cooperation with the second object of interest.

8. A system of providing information corresponding to an object of interest, the system comprising:
means for capturing video along a first direction, the video comprising a series of video images;
means for detecting a first object of interest that is captured in the video;
means for obtaining additional information corresponding to the first object of interest;
means for determining an orientation of a user relative to a display of the display device, where the display is oriented opposite to the first direction;
means for determining portions of each of the video images to be displayed on the display based on the determined orientation of the user relative to the display such that the portions of the video images when displayed are configured to appear to the user as though the display device were not positioned between the user and the first object of interest; and
means for displaying the portions of video images as they are captured and simultaneously displaying the additional information in cooperation with the first object of interest.

9. The system of claim 8, wherein the means for displaying the portions of the video images comprises means for three-dimensionally displaying the portions of the video images to appear to the user has having depth consistent with what the user would otherwise see should the display be removed from the user's field of view.

10. The system of claim 9, wherein the means for displaying the additional information comprises means for displaying the additional information such that the displayed additional information does not interfere with the user's viewing of the first object of interest.

11. The system of claim 8, further comprising:
means for detecting interaction from the user corresponding to the first object of interest;
means for identifying, based on the detected interaction, control information to be communicated to the first object of interest; and
means for communicating the control information to the first object of interest.

12. The system of claim 11, wherein the means for detecting the interaction comprises means for detecting interaction with the displayed additional information.

13. The method of claim 8, wherein the means for capturing the video along the first direction comprises means for capturing the video along the first direction corresponding with a direction of a user's field of view when looking at the display device.
